(19) United States
(12) Patent Application Publication
(10) Pub. No.: US 2013/0264216 A1
(43) Pub. Date: Oct. 10, 2013

(54) ELECTROCATALYTIC ALKENES AND ALKYNES DIMERIZATIONS AND TRIMERIZATIONS

(71) Applicant: BALL STATE UNIVERSITY BOARD OF TRUSTEES, Muncie, IN (US)

(72) Inventors: Daesung Chong, Yorktown, IN (US); Jesse W. Tye, Muncie, IN (US)

(73) Assignee: Ball State University Board of Trustees, Muncie, IN (US)

(21) Appl. No.: 13/856,330

(22) Filed: Apr. 3, 2013

Related U.S. Application Data
(60) Provisional application No. 61/621,672, filed on Apr. 9, 2012.

(51) Int. Cl. B01J 31/22; C25B 3/10

(52) U.S. Cl. CPC B01J 31/22; B01J 31/226; C25B 3/10
USPC 205/415; 556/141; 556/136; 556/46; 556/59; 556/15; 556/16; 556/30; 205/414

(57) ABSTRACT

The present disclosure relates generally to carbon to carbon coupling processes, and more specifically, to dimerization or trimerization by electrocatalysis of alkenes and alkynes at room temperature.

### CROSS REFERENCE TO RELATED APPLICATION

This application claims the benefit of priority to U.S. Provisional Patent Application Ser. No. 61/621,672, filed Apr. 9, 2012, entitled ELECTROCATALYTIC ALKENES AND ALKYNES DIMERIZATIONS AND TRIMERIZATIONS, incorporated herein by reference.

### FIELD OF THE INVENTION

The present disclosure relates generally to carbon to carbon coupling processes, and more specifically, to dimerization or trimerization by electrocatalysis of alkenes and alkynes at room temperature.

### BACKGROUND OF THE INVENTION

There is growing awareness of the efficacy of oxidative electron-transfer (“ET”) processes in inducing cycloaddition reactions and intramolecular cyclizations through either a direct anodic process or one involving an ET mediator. A restraint on this synthetic strategy arises from the requirement that removal of an electron from the intended coupling group must be facile. Thus, the ET-induced coupling of alkenes, which are inherently hard to oxidize, has typically been carried out successfully only on those which are activated (i.e., given lower oxidation potentials) either by delocalization (e.g., stilbenes) or by substitution with one or more electron-donating (e.g., methoxy) groups.

Literature reports an electrocatalytic method that allowed ET-induced cycloaddition reactions of unactivated cyclic alkenes. This electrocatalytic method took advantage of in situ generation of the strong one-electron oxidant [(η⁵-C₅H₅)Re(CO)₃]⁺ (sometimes referred to as “Compound 1”) as an ET mediator and provided a synthetic entry to cycloaddition products that is superior to previously reported methods, which generally require a weeklong photolysis in the presence of Cu(I) catalysts.

Literature reports that anodic oxidation of unactivated cyclic alkenes has been carried out in electrolyte media containing solvents or electrolyte anions that are sufficiently nucleophilic to attack the putative radical cation and account for substituted electrolysis products. The same difficulty was addressed for organometallic radical cations by using a more benign electrolyte medium, for example, dichloromethane/[NBu₄][TFAB] ([B(C₆F₅)₄]⁻), based on a weakly coordinating anion (WCA). This direct oxidation approach is not possible for cyclic alkenes from cyclopentene to cyclooctene (COE), CₙH₂ₙ₋₂, n=5-8, owing to the fact that these compounds show no voltammetric response in the detectable potential window. However, when a 25 mM solution of cis-COE containing a catalytic amount (1 mM) of Compound 1 was electrolyzed at a potential sufficient to form the radical Compound 1⁺ (Eₐₚₚ=1.3 V vs FeCp₂^{0/+}), complete conversion of COE to uncharged organic products occurred within a time frame of several minutes. Similar results were found for the C₅ through C₇ analogues, albeit over somewhat longer electrolysis times.

### SUMMARY OF THE INVENTION

Disclosed herein are metal catalyst complexes and corresponding electrocatalytic methods that lower the half cell potential (E_{1/2}) for carbon to carbon coupling reactions of unactivated alkenes and unactivated alkynes. In some embodiments, the metal catalyst complexes and corresponding electrocatalytic methods disclosed herein lower the half cell potential for carbon to carbon coupling reactions of unactivated cyclic alkenes and alkynes.

One aspect of the present invention pertains to an electrochemical catalyst comprising: a catalyst or any oxidized state of the catalyst, the catalyst having the general formula:

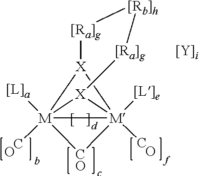

where each M or M′ is independently chosen from Fe, Ru, Os, Mn, Re, Cr, Mo, Co and W; where X is chosen from S, Se, Te, P, and As; where L is chosen from CO, P(Rₐ)₃, As(Rₐ)₃, CN(Rₐ), biphenyl, phenyl, CN⁻, NCH, and N-heterocyclic carbenes; where a is 0 or 2; where b is 1 or 2; where c is 0 or 1; where d is 0 or 1; where f is 0, 1, or 2; where each Rₐ is independently chosen from methyl, ethyl, n-propyl, iso-propyl, n-butyl, sec-butyl, tert-butyl, benzyl, cyclohexyl, adamantyl, phenyl, amino-phenyl, hydroxyphenyl, methylphenyl, trifluoromethylphenyl, methoxyphenyl, diaminophenyl, and 2-phenylphenyl; where g is 0, 1, or 2; and, if g is 2, then X is P or As; where R_{b} is chosen from (CH₂)ₚ(A)_{q}(CH₂)ᵣ, where A is chosen from CH₂, C₆H₄, NH, and O, where q is either 0 or 1, where the sum of p, q, and r does not exceed 5, and where h is 0, 1, 2, or 3; where L′ is chosen from CO, P(Rₐ)₃, As(Rₐ)₃, CN(Rₐ), biphenyl, phenyl, CN⁻, NCH, N-heterocyclic carbenes, and (η⁵-C₅(R_{c})₅); where e is 0, 1, or 2, and, if e is 1, then L′ is (η⁵-C₅(R_{c})₅) and f is 0; where each R_{c} is independently chosen from H and methyl; where Y is chosen from Li⁺, Na⁺, K⁺, Rb⁺, Cs⁺, [NMe₄]⁺, [NEt₄]⁺, [NPr₄]⁺, [NBu₄]⁺, and [Ph₃PNPPh₃]⁺; and where i is 0, 1 or 2.

In a further embodiment, each M or M′ is independently chosen from Fe, Ru, and Os; X is chosen from S, Se, and Te; a is 2; b is 1; d is 1; e is 2; f is 1; g is 0 or 1; and h is 0 or 1.

In another embodiment, each M or M′ is independently chosen from Mn and Re; X is chosen from S, Se, and Te; a is 2; e is 2; f is 1 or 2; g is 0 or 1; and h is 0 or 1.

In a further embodiment, a is 2; b is 1; c is 0; d is 1; f is 0 or 1; g is 0 or 2, and, if g is 2, then X is P or As; h is 0 or 1; and e is 1 or 2, and, if e is 1, then L′ is (η⁵-C₅(R_{c})₅) and f is 0.

In another embodiment, each M or M′ is independently chosen from of Cr, Mo, and W; X is chosen from S, Se, and Te; a is 2; b is 2; c is 0; d is 0; f is 2; g is 0 or 1; h is 0 or 1; and i is 1 or 2.

In a further embodiment, M and M′ are Fe; X is S; a is 2; b is 1; c is 0; d is 1; e is 2; f is 1; g is 1; h is 1; i is 0; L is CO; L′ is CO; Rₐ is CH₂; and R_{b} is chosen from (CH₂)ₚ(A)_{q}(CH₂)ᵣ, where A is CH₂, where q is 0 or 1, where the sum of p, q, and r does not exceed 5.

Another aspect of the present invention pertains to an electrochemical method of carbon to carbon coupling comprising the steps of: providing a reaction mixture comprising a two metal carbonyl catalyst complex and a reactant selected from the group consisting of unactivated alkenes or unactivated alkynes, subjecting the reaction mixture to an electron transfer, and creating at least one new carbon to carbon bond at room temperature.

In some embodiments, the new carbon to carbon bond is coupled to the reactant. In further embodiments, the new carbon to carbon bond is coupled to at least one moiety chosen from a hydrocarbyl group, a hydrocarbylene group, and an organyl group.

In some embodiments, the reaction mixture further comprises a solvent, which may be a non-aqueous solvent, such as dichloromethane.

In some embodiments, the electrolyte chosen from tetrabutylammonium tetrakis pentafluoroarylborate, tetraethylammonium tetrakis pentafluoroarylborate, tetrabutylammonium tetrakis pentafluoroarylborate, tetrabutylammonium hexafluorophosphate and combinations thereof.

In some embodiments, the unactivated alkene is a cyclic alkene, such as cyclooctene, cyclohexene or phenylacetylene. In certain embodiments, where the unactivated alkene is a cyclic alkene, the new carbon to carbon bond is coupled to the cyclic alkene to form dimerized and/or trimerized products, which may include diastereomers.

In some embodiments, the step of creating includes a conversion rate that is greater than fifty percent (50%) or greater than sixty percent (60%).

In some embodiments, the electron transfer is from an externally applied voltage, such as from electrolysis. In further embodiments, the electron transfer is from voltage created by a chemical reaction.

### DESCRIPTION OF THE PREFERRED EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

As used herein, an unactivated alkene or an unactivated alkyne is intended to mean a compound not attached to any electronegative substitutents. Unless otherwise specified, reference to alkyls, including references to alkanes, alkenes, and alkynes, includes straight chain, branched, and cyclical alkyls.

As used herein, a carbon to carbon bond “C—C bond” is intended to mean a bond between a carbon atom and a carbon atom. The carbon atom that is a part of the C—C bond is envisioned to be part of an unactivated alkene or an unactivated alkyne. The carbon atom that is a part of the C—C bond may be part of a hydrocarbyl group, a hydrocarbylene group, or a organyl group.

Embodiments of catalyst complexes including two metals are disclosed. Embodiments of the two metal catalyst complex include any oxidized state of the catalyst.

The two metal catalyst complex has the general formula:

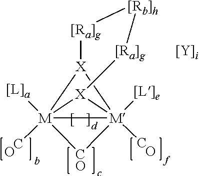

In some embodiments, the complexes include two metals, an optional linker, at least one ligand, and at least one carbonyl group. In certain embodiments each metal is independently chosen from Iron (Fe), Ruthenium (Ru), Osium (Os), Manganese (Mn), Rhenium (Re), Chromium (Cr), Molybdenum (Mo), Cobalt (Co) and Tungsten (W). The metals may be directly coupled to each other. Alternatively, the metals may be coupled via a linker or a plurality of linkers.

In certain embodiments, a linker is a bond between the two metals. In other embodiments, a linker is illustrated as component (X). Each X is independently chosen from Sulfur (S), Selenium (Se), Tellurium (Te), Phosphorus (P), and Arsenic (As). In yet other embodiments, a plurality of linkers are illustrated to include the following general formula:

—[Rₐ]_{g}—[R_{b}]ₕ—[Rₐ]_{g}—

where each Rₐ is independently chosen from methyl, ethyl, n-propyl, iso-propyl, n-butyl, sec-butyl, tert-butyl, benzyl, cyclohexyl, adamantyl, phenyl, amino-phenyl, hydroxyphenyl, methylphenyl, trifluoromethylphenyl, methoxyphenyl, diaminophenyl, and 2-phenylphenyl,

where R_{b} is (CH₂)ₚ(A)_{q}(CH₂)ᵣ where A is chosen from CH₂, C₆H₄, NH, and O, where q is either 0 or 1, where the sum of p, q, and r does not exceed 5.

In certain embodiments, a ligand is illustrated as component (L). Each L is independently chosen from CO, P(Rₐ)₃, As(Rₐ)₃, CN(Rₐ), biphenyl, phenyl, CN⁻, NCH, and N-heterocyclic carbenes. Each L′ is independently chosen from CO, P(Rₐ)₃, As(Rₐ)₃, CN(Rₐ), biphenyl, phenyl, CN⁻, NCH, N-heterocyclic carbenes, and (η⁵-C₅(R_{c})₅), where each R_{c} is independently chosen from H and methyl.

In some embodiments, the complexes additionally include an ion. In some embodiments, the ion is illustrated as component (Y). Y is chosen from Li⁺, Na⁺, K⁺, Rb⁺, Cs⁺, [NMe₄]⁺, [Net₄]⁺, [NPr₄]⁺, [NBu₄]⁺, and [Ph₃PNPPh₃]⁺.

In some embodiments, either a or b is 2, and either e or f is 2. In some embodiments, c is 0 if either the sum of a and b is three or if the sum of e and f is 3.

Embodiments of methods for using the two metal catalyst complexes are disclosed. In general, the method includes the steps of a) providing a reaction mixture comprising a two metal carbonyl catalyst complex or any oxidized state of the catalyst, and a reactant chosen from unactivated alkenes or unactivated alkynes, b) subjecting the reaction mixture to an electron transfer, and c) creating at least one new carbon to carbon bond.

In one embodiment, the reactant includes a cyclic alkene. Unactivated alkenes are useful in the process may be obtained from natural sources or from processes. One skilled in the art would know how to procure alkenes and alkynes useful in the process.

The electrolyte of the process can vary. In one embodiment, the electrolyte is any electrolyte known for use in electrochemical processes. In another embodiment, the electrolyte is a salt of the general formula Z⁺Y⁻. In this general formula, Z is chosen from Li, Na, NBu₄, NMe₄, and NEt₄. Y is chosen from ClO₄, Cl, Br, I, NO₃, BF₄, AsF₆, BPh₄, PF₆, AlCl₄, CF₃SO₃, B(C₆F₅)₄ (illustrated below as Compound A, and also known as “TFAB”), B(C₆H₃(3,5-CF₃)₂)₄ (illustrated below as Compound B, and also known as “BARF”) and SCN. Bu represents butyl groups, Me represents methyl groups, Et represents ethyl groups and Ph represents phenyl groups. In one embodiment, the electrolyte is tetrabutylammonium tetrakis pentafluoroarylborate (TFAB). In yet another embodiment, traditional electrolytes are selected from the group consisting of tetraethylammonium tetrakis pentafluoroarylborate (TFAB), tetrabutylammonium tetrakis pentafluoroarylborate (TFAB), and tetrabutylammonium hexafluorophosphate. The electrolytes of the process may be obtained commercially. One skilled in the art would know how to acquire an electrolyte and use it in the process. It is envisioned to utilize recyclable electrolytes for the electrocatalysis.

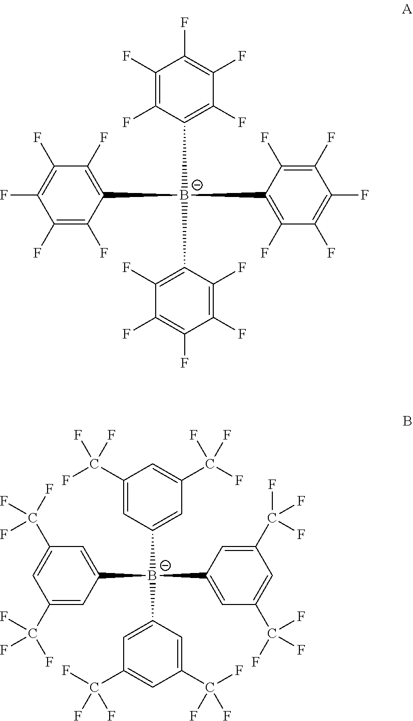

Traditional electrolytes alone have not been found to be beneficial for these reactions. Mixtures of traditional electrolytes with tetrabutylammonium tetrakis pentafluoroarylborate (TFAB) have been found beneficial for these reactions.

The optional solvent used in the process may be any solvent that does not react with metal catalysts and that is itself oxidized only at a more positive potential than the catalysts. The solvents are those in which the compounds used are at least partially soluble under operational conditions with respect to concentration and temperature. In one embodiment, the solvent is chosen from dichloromethane, dichloroethane, tetrahydrofuran, acetonitrile, butyrolactone, dimethoxyethane with nitromethane, 1,3-dioxolane, liquid SO₂, tris(dioxa-3,6-heptyl)amine, trimethylurea, dimethyl formamide, dimethylsulfoxide, 1,2-dimethoxyethane, bis(2-methoxyethyl)ether, p-dioxane and hexamethylphosphoramide, and mixtures of these solvents; in another embodiment, the solvent is dichloromethane. Solvents useful in the process are commercially available.

The process can be carried out in any conventional way, using one or more electrolytic cells having a cathode and an anode. The electrolytic cells may be divided or undivided electrolytic cells. The applied voltage can vary, and the electrical connections for the divided cells may be monopolar or dipolar. In one embodiment, the applied voltage is greater than or equal to the peak potential for a given anode and cathode. The “peak potential,” as used herein, is intended to mean the cathodic peak potential as observed in cyclic voltammetry. One skilled in the art would know how to measure the oxidative and reduction peak potentials for particular electrode materials using cyclic voltammetry in a non-aqueous electrochemical cell.

In an exemplary embodiment of the present disclosure, an electrolytic cell is provided with a potentiostat or a galvanostat in order to control the potential or the intensity of the current. At larger scales, a rectifier may be used to control current intensity and potential. The reaction can be carried out with and without a controlled potential, but the potential is typically at least equal to the peak potential.

The electrodes which can be used as the cathode are typically made of graphite or an inert metal such as gold, silver, platinum, or another metal or and alloy which is relatively inert, such as stainless steel. As used herein, “inert” is intended to mean that the cathode does not undergo chemical change under the reaction conditions selected. The counter electrode, or anode, may be comprised of any materials which have adequate electric conductivity and are chemically inert under the reaction conditions selected.

The process may take place under a deoxygenated and dry or nearly dry atmosphere. This atmosphere may be deoxygenated and dried by purging with an inert gas, such as with nitrogen, argon, or helium. Nitrogen is the typical inert gas used. The atmosphere may also be deoxygenated through the use of a sealed continuous closed process. In such case, inert gas is typically only used at the beginning of the process and used in a small amount compared to other processes.

The electrolytic appliance according to an embodiment of the present disclosure can be any appliance typically used for electrolysis and suitable for the electrode configuration of the process. In one embodiment, the electrolysis equipment used is a standard three-compartment “H-type” electrolytic cell having counter electrode and working electrode compartments, and experimental reference electrode and working electrode compartments, separated by a fine glass frit. Types and designs of equipment used for electrolysis are well known in the art, so one skilled in the art would know how to design or select the appropriate apparatus for use with the process of the invention.

### EXAMPLES

TABLE 1
Abbreviations and definitions of selected terms used in the examples.

| Abbreviation | Term |
|---|---|
| CH₂Cl₂ | Dichloromethane or methylenechloride |
| g | Gram |
| GC-MS | Gas chromatography-mass spectroscopy |
| Eₐₚₚ | Applied voltage |
| mV | Millivolts |
| Me | Methyl, CH₃— |
| Et | Ethyl, CH₃CH₂— |
| Bu | Butyl, CH₃CH₂CH₂CH₂— (and iso-, sec-, |
| | and tert-butyl) |
| V | Volt |
| μm | Micrometer |
| F | Faradays |
| Equiv | Equivalent |
| mg | Milligram |
| % conversion | (g of products ÷ g of reactant) × 100% |
| Unactivated | A compound containing a carbon-carbon |
| alkene | double bond (C═C) which is not attached |
| | to any of a number of electronegative |
| | substitutents |
| Unactivated | A compound containing a carbon-carbon |
| alkyne | triple bond (C≡C) which is not attached to |
| | any of a number of electronegative |
| | substitutents |

All electrochemical experiments were performed in a MBRAUN drybox under Argon. The electrochemical cell was dried for at least 24 hours at 120° C. and introduced into the antechamber while still warm, to minimize moisture on the glassware. Electrochemical experiments were conducted using a Princeton Applied Research model 273A potentiostat interfaced to a personal computer. Glassy carbon working electrodes of 1 or 2 mm diameter (as made available by Bioanalytical Systems) were pretreated using a standard sequence of polishing procedures employing diamond paste (by Buehler or BioAnalytical Systems Incorporated (BASi)) of decreasing sizes from 3 to 1 μm, each one interspersed with washing of the electrode with nanopure water. Finally, the electrode was vacuum-dried. The auxiliary electrode was a reusable platinum wire for voltammetry experiments and a platinum or nickel mesh for bulk electrolyses. The working electrode for the latter experiments was a large reusable platinum or nickel mesh. The experimental reference electrode was a silver/silver chloride electrode made by freshly anodizing a silver wire in a 0.1 M HCl solution, followed by washing with water and vacuum drying. Unless otherwise noted, all potentials in this disclosure are referred to the ferrocene/ferrocenium couple, the potential of which was obtained by the in situ method. In some embodiments, the electrode and the electrolyte are reused after removal and separation of the compounds produced by the process.

Tetrabutylammonium tetrakis pentafluoroarylborate (TFAB), [NBu₄][B(C₆F₅)₄], as an electrolyte was prepared by metathesis of either [Li(OEt)ₙ][B(C₆F₅)₄] or K[B(C₆F₅)₄] (by Boulder Scientific Co.) with [NBu₄]Br in methanol/water and recrystallized several times from dichloromethane/diethyl ether.

The identity and quantity of compounds produced by the process may be determined by gas chromatography (GC), gas chromatography-mass spectrometry (GC-MS), nuclear magnetic resonance (NMR) spectroscopy, or other suitable techniques. One skilled in the art would know how to determine the identity and quantity of C₁₆ compounds using suitable techniques, such as GC or GC-MS. For example, GC-MS measurements may be performed using an Agilent Technologies 6890 GC equipped with a 24233-U SPB™-Octyl L column and 5975 B mass detector. It is envisioned that other commercially available columns and mass detectors may be used. Products may be determined using molecular mass and mass fragmentation patterns.

### Example 1

Experimental catalysis conditions: 8 mg (20 μmol) of diiron carbonyl catalysts, as listed in Table 2, and 55 mg (500 μmol) of COE (cyclooctene) in 5 mL of 0.05 M to 0.1 M [NBu₄][B(C₆F₅)₄]/CH₂Cl₂ under nitrogen or argon at 293 K to 298 K for 30 min; add 30 mL of hexanes or n-pentane to precipitate supporting electrolyte; filter with M frit, evaporate, extract with ether, hexanes, or n-pentane, and elute with hexane through activated alumina or neutral silica gel, affording 30 mg of a colorless oil shown to be a mixture of dimerized products and their diastereomers.

TABLE 2
Diiron carbonyl catalysts.

| Diiron carbonyl | | |
|---|---|---|
| catalyst | Eₐₚₚ | Nomenclature |
| Ethylene | 1.0 V | M = Fe, M′ = Fe, X = S, a = 2, b = 1, c = 0, d = 1, e = 2, f = 1, g = 1, |
| dithiolate | | h = 1, i = 0, L = CO, L′ = CO, Rₐ = CH₂ R_{b} = |
| | | CH₂(p = 0)(A = CH₂)(q = 0)CH₂(r = 0) |
| Propylene | 1.0 V | M = Fe, M′ = Fe, X = S, a = 2, b = 1, c = 0, d = 1, e = 2, f = 1, g = 1, |
| dithiolate | | h = 1, i = 0, L = CO, L′ = CO, Rₐ = CH₂ R_{b} = |
| | | CH₂(p = 0)(A = CH₂)(q = 1)CH₂(r = 0) |
| Butylene | 0.9 V | M = Fe, M′ = Fe, X = S, a = 2, b = 1, c = 0, d = 1, e = 2, f = 1, g = 1, |
| dithiolate | | h = 1, i = 0, L = CO, L′ = CO, Rₐ = CH₂ R_{b} = |
| | | CH₂(p = 1)(A = CH₂)(q = 0)CH₂(r = 1) |
| Pentylene | 0.7 V | M = Fe, M′ = Fe, X = S, a = 2, b = 1, c = 0, d = 1, e = 2, f = 1, g = 1, |
| dithiolate | | h = 1, i = 0, L = CO, L′ = CO, Rₐ = CH² R_{b} = |
| | | CH₂(p = 1)(A = CH₂)(q = 1)CH₂(r = 1) |

Dimerized products of cyclooctene and diastereomers of these dimerized products are generally characterized as bi- or tricyclohexadecane, C₁₆ compounds. The conversion rate of cyclooctenes to dimerized products using these catalysts was determined to be greater than fifty percent (50%) by mass, greater than sixty percent (60%) by mass, and specifically, about sixty-six percent (66%) by mass.

As shown in Table 2, applied potential using the exemplary diiron carbonyl catalysts (Eₐₚₚ=0.7 V to 1 V) has been lowered relative to previous testing using the rhenium catalyst, [(η⁵-cyclopentadienyl)Re(CO)₃]⁺ (Eₐₚₚ=1.3 V). As the length of the carbonyl moiety of the diiron carbonyl catalyst increases in length from propyl to pentyl, the applied potential is lessened (1 V to 0.7 V, respectively). A smaller applied potential is indicative of a smaller half cell potential. It is envisioned that a large group of two metal carbonyl catalyst complexes such as the provided genus would have the same functionality as the examined diiron carbonyl catalysts.

### Example 2

Experimental catalysis conditions: 7 mg (18 μmol) of diiron carbonyl catalysts (the propyl, butyl, and pentyl thiolate catalysts listed in Table 2) and 10 mg (98 μmol) of phenylacetylene in 5 mL of 0.05 M to 0.1 M [NBu₄][B(C₆F₅)₄]/CH₂Cl₂ under nitrogen or argon; potentiostatic electrolyze (Eₐₚₚ=1 V when carbonyl of diiron carbonyl catalyst is propyl dithiolate; Eₐₚₚ=0.9 V when carbonyl of diiron carbonyl catalyst is butyl dithiolate; and Eₐₚₚ=0.7 V when carbonyl of diiron carbonyl catalyst is pentyl dithiolate) at 293 K to 298 K for 30 min; add 30 mL of hexanes or n-pentane to precipitate supporting electrolyte; filter with M frit, evaporate, extract with ether, hexanes, or n-pentane, and elute with hexane through activated alumina or neutral silica gel, affording 30 mg of a beige oil shown to be a mixture of dimerized products. Dimerized products of phenylacetylene are generally characterized as C16 compounds. Mass: cis and trans PhCH═CH—CECPh, M⁺ at m/z=204; the gas chromatogram retention time of cis- and trans-PhCH═CH-CECPh isomers are not the same. Products were verified by running GC-MS of commercially available authentic samples. After the reaction was completed, the product yields were determined directly by GC-MS and GC calibration curves.

### Example 3

Experimental catalysis conditions: 7 mg (18 μmol) of diiron carbonyl catalysts (the propyl, butyl, and pentyl thiolate catalysts listed in Table 2) and 54 mg (658 μmol) of cyclohexene in 5 mL of 0.05 M to 0.1 M [NBu₄][B(C₆F₅)₄]/CH₂Cl₂ under nitrogen or argon; potentiostatic electrolyze (Eₐₚₚ=1 V when carbonyl of diiron carbonyl catalyst is propyl dithiolate; Eₐₚₚ=0.9 V when carbonyl of diiron carbonyl catalyst is butyl dithiolate; and Eₐₚₚ=0.7 V when carbonyl of diiron carbonyl catalyst is pentyl dithiolate) at 293 K to 298 K for 30 min; add 30 mL of hexanes or n-pentane to precipitate supporting electrolyte; filter with M frit, evaporate, extract with ether, hexanes, or n-pentane, and elute with hexane through activated alumina or neutral silica gel, affording 30 mg of a colorless oil shown to be a mixture of dimerized and trimerized products. Dimerized products are generally characterized as C12 compounds. Trimerized products are generally characterized as C18 compounds. All products were verified by running GC-MS and mass analysis.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed:

1. An electrochemical catalyst comprising:
a catalyst or any oxidized state of the catalyst, the catalyst having the general formula: 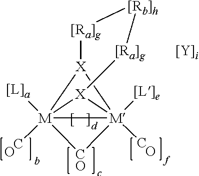
where each M or M′ is independently chosen from Fe, Ru, Os, Mn, Re, Cr, Mo, Co and W;
where X is chosen from S, Se, Te, P, and As;
where L is chosen from CO, P(Rₐ)₃, As(Rₐ)₃, CN(Rₐ), biphenyl, phenyl, CN⁻, NCH, and N-heterocyclic carbenes;
where a is 0 or 2;
where b is 1 or 2;
where c is 0 or 1;
where d is 0 or 1;
where f is 0, 1, or 2;
where each Rₐ is independently chosen from methyl, ethyl, n-propyl, iso-propyl, n-butyl, sec-butyl, tert-butyl, benzyl, cyclohexyl, adamantyl, phenyl, amino-phenyl, hydroxyphenyl, methylphenyl, trifluoromethylphenyl, methoxyphenyl, diaminophenyl, and 2-phenylphenyl;
where g is 0, 1, or 2, and, if g is 2, then X is P or As;
where R_{b} is chosen from (CH₂)ₚ(A)_{q}(CH₂)ᵣ, where A is chosen from CH₂, C₆H₄, NH, and O, where q is 0 or 1, where the sum of p, q, and r does not exceed 5;
where h is 0, 1, 2, or 3;
where L′ is chosen from CO, P(Rₐ)₃, As(Rₐ)₃, CN(Rₐ), biphenyl, phenyl, CN⁻, NCH, N-heterocyclic carbenes, and (η⁵-C₅(R_{c})₅), where each R_{c} is independently chosen from H and methyl;
where e is 0, 1, or 2, and, if e is 1, then L′ is (η⁵-C₅(R_{c})₅) and f is 0;
where Y is chosen from Li⁺, Na⁺, K⁺, Rb⁺, Cs⁺, [NMe₄]⁺, [Net₄]⁺, [NPr₄]⁺, [NBu₄]⁺, and [Ph₃PNPPh₃]⁺; and
where i is 0, 1 or 2.

2. The catalyst of claim 1,
where each M or M′ is independently chosen from Fe, Ru, and Os;
where X is chosen from S, Se, and Te;
where a is 2;
where b is 1;
where d is 1;
where e is 2;
where f is 1;
where g is 0 or 1; and
where h is 0 or 1.

3. The catalyst of claim 1,
where each M or M′ is independently chosen from Mn and Re;
where X is chosen from S, Se, and Te;
where a is 2;
where e is 2;
where f is 1 or 2;
where g is 0 or 1; and
where h is 0 or 1.

4. The catalyst of claim 1,
where a is 2;
where b is 1;
where c is 0;
where d is 1;
where f is 0 or 1;
where g is 0 or 2, and, if g is 2, then X is P or As,
where h is 0 or 1; and
where e is 1 or 2, and, if e is 1, then L′ is (η⁵-C₅(R_{c})₅) and f is 0.

5. The catalyst of claim 1,
where each M or M′ is independently chosen from of Cr, Mo, and W;
where X is chosen from S, Se, and Te;
where a is 2;
where b is 2;
where c is 0;
where d is 0;
where f is 2;
where g is 0 or 1;
where h is 0 or 1; and
where i is 1 or 2.

6. The catalyst of claim 1, wherein M and M′ are Fe;
where X is S;
where a is 2;
where b is 1;
where c is 0;
where d is 1;
where e is 2;
where f is 1;
where g is 1;
where h is 1;
where i is 0;
where L is CO;
where L′ is CO;
where Rₐ is CH₂; and
where R_{b} is chosen from (CH₂)ₚ(A)_{q}(CH₂)ᵣ, where A is CH₂, where q is 0 or 1, where the sum of p, q, and r does not exceed 5.

7. An electrochemical method of carbon to carbon coupling, comprising the steps of:
providing a reaction mixture comprising a two metal carbonyl catalyst complex or any oxidized state of the catalyst, an electrolyte, and a reactant chosen from unactivated alkenes and unactivated alkynes;
subjecting the reaction mixture to an electron transfer; and
creating at least one new carbon to carbon bond.

8. The method of claim 7, wherein the new carbon to carbon bond is coupled to the reactant.

9. The method of claim 7, wherein the new carbon to carbon bond is coupled to at least one moiety chosen from a hydrocarbyl group, a hydrocarbylene group, and an organyl group.

10. The method of claim 7, wherein the reaction mixture further comprises a solvent.

11. The method of claim 10, wherein the solvent is non-aqueous.

12. The method of claim 10, wherein the solvent is dichloromethane.

13. The method of claim 7, wherein the electrolyte is chosen from tetrabutylammonium tetrakis pentafluoroarylborate, tetraethylammonium tetrakis pentafluoroarylborate, tetrabutylammonium tetrakis pentafluoroarylborate, tetrabutylammonium hexafluorophosphate and combinations thereof.

14. The method of claim 13, wherein the electrolyte is tetrabutylammonium tetrakis pentafluoroarylborate.

15. The method of claim 7, wherein the unactivated alkene is a cyclic alkene.

16. The method of claim 15, wherein the cyclic alkene is chosen from cyclooctene, cyclohexane, and phenylacetylene.

17. The method of claim 15, wherein the new carbon to carbon bond is coupled to the cyclic alkene to form at least one of dimerized products and trimerized products.

18. The method of claim 17, wherein the at least one of dimerized products and trimerized products include diastereomers.

19. The method of claim 7, wherein the step of creating includes a conversion rate that is greater than fifty percent (50%).

20. The method of claim 19, wherein the step of creating includes a conversion rate that is greater than sixty percent (60%).

21. The method of claim 7 wherein the electron transfer is from an externally applied voltage.

22. The method of claim 21 wherein the electron transfer is from electrolysis.

23. The method of claim 7 wherein the electron transfer is from voltage created by a chemical reaction.
